(19) United States
(12) Patent Application Publication
(10) Pub. No.: US 2006/0186104 A1
(43) Pub. Date: Aug. 24, 2006

(54) Fluid deposition of electrically conductive strips and articles having solid electrically conductive strips obtained therefrom

(76) Inventor: John A. Winter, Pittsburgh, PA (US)

Correspondence Address: PPG Industries, Inc., One PPG Place, Pittsburgh, PA, 15272, US

(21) Appl. No.: 11/062,423

(22) Filed: Feb. 22, 2005

(51) Int. Cl. B60L 1/02

(52) U.S. Cl. 219/203

(57) ABSTRACT

An electrically conductive, minuscule size particle containing liquid solution or particle free liquid solution is applied, e.g. by ink jet printing technique to a surface, e.g. the surface of a glass sheet and drying the applied liquid in any convenient manner, e.g. during the heat treatment, or shaping, of the sheet to dry the liquid which results in the metal solute of the liquid solution to dry and adhere together to provide a solid electrically conductive strip on the glass surface. In one non-limiting embodiments of the invention, the solid conductive strips are a plurality of spaced conductive strips having a width no greater than 0.20 millimeters in the vision area of an automotive windshield.

### BACKGROUND OF THE INVENTION

1. Field of the Invention

This invention relates to fluid deposition of electrically conductive strips or lines and to articles having such solid electrically conductive strips or lines, and more particularly, to applying strips of an electrically conductive, minuscule size particle containing, or particle free, liquid solution, e.g. applying the liquid solution by an ink jet process and thereafter drying the applied solution to provide solid electrically conductive strips, and to transparencies, e.g. automotive transparencies, having the solid conductive strips, e.g. spaced electrically heatable conductive strips.

2. Technical Considerations

Transparencies for enclosures, e.g. vehicles such as automobiles, structures such as residential homes and commercial buildings, and storage compartments such as refrigerators and freezers, are provided with electrically conductive members, e.g. spaced electrically conductive strips or lines to, among other things, conduct current therethrough to heat the transparency. By way of illustration and not limiting the discussion thereto, automotive windshields and automotive rear windows or backlights are provided with an electrically conductive member through which current is moved to heat one or more of the major surfaces of the windshield or rear window to remove moisture, e.g. ice, snow and/or condensation from at least the vision area of the windshield and rear window.

One technique of providing transparencies with an electrically conductive member is to embed tungsten wires with a specific designed linear resistance and a diameter equal to or less than 0.05 millimeters (“mm”), e.g. 0.025 mm into the interlayer or plastic sheet of a laminated windshield prior to lamination of the glass sheets to the interlayer. Although this technique is acceptable there are limitations. For example, embedding wires in the plastic interlayer can cause distortion of the plastic interlayer resulting in optical distortion in the vision area of the windshield. Additional limitations include investment to purchase and maintain the equipment to embed the wires in the interlayer.

As can be appreciated by those skilled in the art, it would be advantageous to provide a transparency having, and a process of applying, electrically conductive strips or lines that minimizes, if not eliminates, the limitations of the above-mentioned process of embedding wires in a plastic sheet.

### SUMMARY OF THE INVENTION

This invention relates to a transparency selected from a transparency for a land, air, space, above water and below water vehicle; a transparency for residential and commercial structures, and a transparency for viewing into a compartment. In a non-limiting embodiment of the invention, the transparency includes a solid electrically conductive strip having a first surface adhered to a surface portion of the transparency, the conductive strip having conductive particles bonded together as a result of evaporation of a conductive solute of a conductive liquid solution.

In another non limiting embodiment of the invention, the solid conductive strip is a portion of an electrically conductive member selected from (a) a plurality of spaced electrically conductive strips, each strip having a first end in electrical contact with a first bus bar and an opposing end in electrical contact with a second bus bar; (b) an electrically heatable member on one surface of a substrate to heat an area of an opposing surface of the substrate opposite the heatable member; (c) a detector for cracks in the transparency; (d) an antenna for receiving and/or transmitting signals; (e) security systems sensor lines on glass; (f) on-glass break detector for vehicle and home windows; (g) antitheft lines for automotive transparencies; and (h) a slot antenna on glass.

The invention also relates to a transparency for an automobile, having, among other things at least one glass sheet having a first major surface and an opposite second major surfaces, and a plurality of spaced solid electrically conductive strips having a first surface and an opposite second surface, one end of the strips connected to a first bus bar and other end of the strips connected to a second bus bar, the bus bars and first surface of the conductive strips secured to the first major surface of the at least one glass sheet, wherein the conductive strip has conductive particles bonded together as a result of evaporation of a conductive solute of a conductive liquid solution. In one non-limiting embodiment of the invention, the conductive strips are in the vision area of windshield and at least a portion of the strips have a width of no greater than 0.20 millimeters, e.g. no greater than 0.15 millimeters, or no greater than 0.10 millimeters, or no greater than 0.05 millimeters.

The invention further relates to a method of applying an electrically conductive strip to a transparency selected from the group of a transparency for a land, air, space, above water and below water vehicle; a transparency for a residential and commercial structure, and a transparency for viewing into a compartment. The method includes, among other things, the steps of applying an electrically conductive, minuscule size particle containing liquid solution or electrically conductive particle free liquid solution to a surface of the transparency to provide a liquid conducting member, and heating the liquid conducting member to provide a solid conductive member adhered to the surface of the transparency.

In non-limiting embodiments of the invention the applying step is practiced by applying the liquid solution using contact application techniques, e.g. painting with a brush, painting with a porous flexible liquid holding member, dispensing the liquid solution by a pen, such as but not limited to a fountain pen, a felt tip pen and a ball point pen, and non-contact application techniques, e.g. spraying the liquid solution and applying the liquid solution by non-contact printing.

In other non-limiting embodiments of the invention the liquid solution is an electrically conductive, minuscule size particle containing liquid solution having on the average no more than one particle per 5 cubic centimeters of liquid solution and maximum linear distance between two points on the periphery of the one particle of no more than 95% of the opening of orifice of the ink jet printer, the one particle defined as large particle, with other particles in the liquid solution having a maximum linear distance of no greater than the large particle.

The invention still further relates to a method of applying an electrically conductive strip to a vehicle transparency having an area designated as a vision area, including, among other things the steps of providing a glass sheet having an area designated as the vision area, applying electrically conductive first and second spaced apart bus bars to a surface of the glass sheet, and applying a plurality of spaced conductive strips in the vision area of the glass sheet, wherein a first end of each of the conductive strips is in electrical contact with the first bus bar and an opposing end of each of the conductive strips is in electrical contact with the second bus bar. The step of applying the conductive comprises, among other things, the steps of applying an electrically conductive, minuscule size particle containing liquid solution or electrically conductive particle free liquid solution by an inkjet application technique to the surface of the glass sheet to provide a plurality of spaced liquid electrically conductive strips on the surface of the glass sheet, and heating the liquid conductive members to provide a plurality of spaced solid electrically conductive strips adhered to the vision area of the glass sheet. In a non-limiting embodiment of the invention, the width of the conductive strips are no greater than 0.20 millimeters, for example no greater than 0.15 millimeters, or no greater than 0.10 millimeters, or no greater than 0.05 millimeters.

The invention in addition relates to method of repairing a short in an electrically conductive strip of a conductive member mounted on a surface of a substrate, including, among other things, the steps of locating the short; applying an electrically conductive, minuscule size particle containing liquid solution or electrically conductive particle free liquid solution to the area of conductive strip having the short, and heating the liquid solution to provide a solid conductive member adhered to the conductive strip over the area having the short.

### BRIEF DESCRIPTION OF THE DRAWINGS

FIG. 1 is a plan view of an automotive windshield incorporating features of the invention and having portions removed for purposes of clarity.

FIG. 2 is a view taken along lines 2-2 of FIG. 1.

FIG. 3 is a fragmented plan view having portions removed for purposes of clarity showing the upper and lower center portions of another non-limiting embodiment of a windshield incorporating features of the invention.

FIG. 4 is a fragmented plan view having portions removed for purposes of clarity showing the lower center portion of another non-limiting embodiment of a windshield incorporating features of the invention.

FIG. 5 is a fragmented plan view having portions removed for purposes of clarity showing the center portion of another non-limiting embodiment of a windshield incorporating features of the invention.

### DETAILED DESCRIPTION OF THE INVENTION

As used herein, spatial or directional terms, such as “inner”, “outer”, “left”, “right”, “up”, “down”, “horizontal”, “vertical”, and the like, relate to the invention as it is shown in the drawing figures. However, it is to be understood that the invention can assume various alternative orientations and, accordingly, such terms are not to be considered as limiting. Further, all numbers expressing dimensions, physical characteristics, and so forth, used in the specification and claims are to be understood as being modified in all instances by the term “about”. Accordingly, unless indicated to the contrary, the numerical values set forth in the following specification and claims can vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Moreover, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 6.7, or 3.2 to 8.1, or 5.5 to 10. Also, as used herein, the terms “deposited over”, “applied over”, or “provided over” mean deposited, applied, or provided on but not necessarily in surface contact with. For example, a material “deposited over” a substrate does not preclude the presence of one or more other materials of the same or different composition located between the deposited material and the substrate.

Before discussing non-limiting embodiments of the invention, it is understood that the invention is not limited in its application to the details of the particular non-limiting embodiments shown and discussed herein since the invention is capable of other embodiments. Further, the terminology used herein to discuss the invention is for the purpose of description and is not of limitation. Still further, unless indicated otherwise in the following discussion, like numbers refer to like elements.

In general, the invention relates to the application of a liquid solution having a metal precursor, carrier vehicle and other additives, e.g. adhesion promoters and/or dispersants, and drying the applied liquid to provide an electrically conductive metal area. In the preferred practice of the invention the liquid solution is an electrically conductive, minuscule size particle containing, or particle free, liquid solution. The liquid solution is applied to a surface in any convenient, e.g. but not limiting to the invention as liquid strips or lines and is dried in any convenient manner, e.g. heating the applied liquid strips to provide solid electrically conductive strips or lines.

The term “minuscule size particle containing liquid solution” means the particles in the liquid solution are in the range of greater than 0 and equal to or less than 100 micron, for example equal to or greater than 10 microns and equal to or less than 100 microns, or in the range of equal to or greater than 10 microns to equal to or less than 75 microns. The term “particle free” means that the solution is free of particles. Having particles present in the liquid solution in the above ranges, the non-limiting embodiments of the invention can be practiced to apply the electrically conductive, minuscule size particle containing liquid solution or particle free liquid solution to a surface to obtain electrically conductive strips or lines having a narrow width, e.g. but not limiting to the invention a width of no greater than 0.20 millimeters, or no greater than 0.15 millimeters, or no greater than 0.10 millimeters or no greater than 0.05 millimeters, while minimizing, if not eliminating clogging of the orifice though which the liquid solution is moved.

In one non-limiting embodiment of the invention, the liquid solution has on the average no more than one particle (a “large particle”) per 5 cubic centimeters of liquid solution and the maximum linear distance between two points on the periphery of the particle is no more than 95% of the opening of the applicator applying the liquid, with the other particles in the liquid solution having maximum linear distances between two points on their periphery no greater than that of the large particle. In this manner there is no agglomeration of particles at the opening of the applicator applying the liquid solution to clog the opening.

For ease of discussion the term “electrically conductive, minuscule size particle containing, or particle free, liquid solution” will also be referred to in the following discussion and in the claims as the “conductive liquid solution.”

The non-limiting embodiments of the instant invention are significantly different from the process disclosed in French Patent No. 2,750,419, which discloses ejecting droplets of an electrically conductive enamel composition from openings of an ink jet printer onto a surface of a glass sheet. Unlike the conductive liquid solution of the instant invention, the enamel composition of the French patent includes conductive materials and frits with particle sizes greater than minuscule size particles in the conductive liquid solution.

As is appreciated, the invention is not limited to the composition of the conductive liquid solution. For example and not limiting to the invention, conductive liquid solutions disclosed in the Conference Paper written by C. Curtis, T. Rivkin, A. Miedaner, J. Alleman, J. Perkins, L. Smith and D. Ginley titled “Metallizations by Direct-Write Inkjet Printing” dated October 2001, for presentation at the NCPV Program Review Meeting Lakewood, Colo., Oct. 14-17, 2001, and in the article written by Lee Smith and titled “Development of Direct Write Ink Jet for Deposition of Silver Contacts” dated Jul. 26, 2001, can be used in the practice of the invention. In general, the conductive liquid solutions disclosed in the above-identified publications use organometallic precursors as both a metal-forming component of the ink and as a “glue” to bond the nanoparticles together and to enhance adhesion of the ink to the substrate. One non-limiting conductive liquid solution includes silver (hexafluoroacetylacetonate)(1,5-cyclooctadiene) or Ag(hfa)(COD) dissolved in an organic solvent such as toluene, ethanol or butanol. To increase the silver loading of the ink and obtain higher deposition rates, silver or other metal nanoparticles can be added to the ink along with the organometallic precursor. In this non-limiting configuration, the silver particles remaining after the ink is heated, e.g. heated to 572° F. (300° C.), make up the main conducting volume of the resultant coating, while the organometallic constituent acts as a glue for the silver particles, providing enhanced electrical and mechanical bonding of the metal particles with the substrate and between themselves.

Another non-limiting conductive liquid solution that can be used in the practice of the invention is disclosed in presentation prepared by Junfeng Mei, Michael Lovell, and Marlin Mickle and titled “Formulation and Processing of Conductive Inks for Inkjet printing Electrical Circuits” for the Solid Free-Form Fabrication Conference at the University of Texas, August 2004, (hereinafter referred to as the “Mei et al. paper”). The conductive liquid solutions disclosed in the Mei et al. paper are aqueous solution inks and organic solution inks for ink jet printers. The above-identified papers and article are incorporated herein by reference.

One non-limiting composition of aqueous conductive liquid solution that can be used in the practice of the invention discussed in the Mei et al. paper includes 2.19 grams of silver nitrate dissolved in 1 milliliter of water. The dissolved silver nitrate starts to decompose to silver at 824° F. (440° C.) and is completely decomposed at above 932° F. (500° C.). The complete decomposition occurs at lower temperatures at longer times, and at higher temperatures at shorter times, e.g. decomposition of the silver nitrate at 905° F. (485° C.) at 20 minutes and decomposition of the silver nitrate at 995° F. (535° C.) at 5 minutes. Additives, e.g. but not limiting to the invention metallic-organic decomposition (“MOD”) compounds, e.g. organometallic precursors known in the art, can be added to the aqueous solution to slow down thermolysis, adjust surface tension of the molten silver nitrate, bond the decomposed metal silver to glass substrate, and are chemically and physically compatible with the silver nitrate solution. Another non-limiting solution that can be used in the practice of the invention and disclosed in the Mei et al. paper includes silver nitrate in the range of 0.4-1.5 grams per ml of water and additives in the range of 0.05-0.4 grams per ml of water. For a solution of 1 gram of silver nitrate and 0.2 grams of additive per 1 ml of water, the electrical resistivity of the deposited silver was 4.6E-6 (ohm cm), which is 2.9 times the electrical resistivity of bulk silver [1.6E-6 (ohm cm)].

A non-limiting composition of an organic conductive liquid solution discussed in the Mei et al. paper that can be used in the practice of the invention includes Ag (hfac) (COD) MOD, with the MOD precursor being C₁₀H₁₉AgO₂. The organic liquid solution is applied to a substrate by ink jet printing, and the substrate heated to 212° F. (100° C.) to evaporate the solvent, and subsequently to 592° F. (350° C.) for 20 minutes to fuse the silver. The silver provided a conductive area of 95% weight percent silver.

In the practice of the invention, but not limiting thereto, the aqueous conductive liquid solutions disclosed in the Mei et al. paper can be used. As is appreciated, the aqueous and organic compositions disclosed in the Mei et al. paper are proprietary to the authors of the Mei et al. paper, and for details regarding the compositions inquires should be directed to the authors of the Mei et al. paper. Further, for a detailed discussion regarding the bonding of the conductive metal particles, e.g. but not limiting thereto gold and silver in the solute of the solution, reference should be made to Mei et al. paper.

In the practice of the invention, the conductive liquid solution is applied to a surface in any convenient manner, e.g. but not limiting to the invention, by contact application, e.g. but not limiting to the invention, by painting with a brush or porous flexible liquid holding member, dispensing the liquid solution by a fountain pen, by a felt tip pen or by a ball point pen, and/or by non-contact application, e.g. but not limiting to the invention, by spraying, and non-contact printing. Non-contact printing includes, but is not limited to, applying the conductive liquid solution using “inkjet printers” or “bubble printers” or other similar application equipment. In the following discussion of the invention, but not limited thereto, the conductive liquid solution is applied by ink jet printing.

Briefly described, ink jet printing involves projecting one or more droplets of an ink jet composition, in this discussion one or more droplets of the conductive liquid solution, from one or more openings located in one or more ink jet print heads to points on the surface of a substrate, e.g. but not limited to points on a surface of a glass or plastic sheet or blank to be printed. The stream of conductive liquid solution droplets as they move toward the substrate surface are controlled electronically so that the droplets are caused to form the desired printed image on the substrate surface.

The inkjet application technique makes it possible to print any type of pattern on various types of surfaces without the need for changing the print elements as a function of the pattern to be printed (unlike the silk screening process where each pattern requires a separate silk screen). The pattern can be changed rapidly by electronic programming to control droplet ejection. Print speed can be very high and the pattern can be changed very quickly (e.g., a few hundredths of a second from the time the pattern is recorded in the control system) and requires no additional material, as indicated above. Since this particular non-limiting process used in the practice of the invention is a printing process (e.g., no contact between a printing form, such as a stamp, and the substrate to be printed), it also allows for marking, at and low high speeds, any substrate e.g. but not limiting the invention thereto, flat or curved substrates without regard to the firmness of the substrate, in other words very thin substrates, e.g. a few millimeters thick, can be printed.

The use of the inkjet application technique to apply electrically conductive strips or lines of different patterns provides several other advantages. Because it is a non-contact method of line application, material can be applied over a previously deposited pattern while the previous pattern is wet or dry. More particularly, the conductive liquid solution can be applied over previously deposited electrically conductive lines, and/or over a previously deposited line of conductive liquid solution, to reduce the resulting line's electrical resistance without increasing the overall width of the line and/or to repair previously deposited conductive strips or lines. Further, electrically conductive strips or lines of the conductive liquid solution can be deposited over a previously deposited conductive strip or line of the same or different composition. For example, but not limiting to the invention thereto, a strip of conductive liquid solution can be applied over a previous deposed liquid conductive strip, a solid conductive strip, or over a previously deposited opaque ceramic paint band of a type well known in the art, before the ceramic band is processed, e.g. to heat the substrate and/or cure the ceramic paint.

As discussed above, the strips of the conductive liquid solution applied to the surface are heated to provide the solid conductive lines. The solid conductive lines have a rough or uneven thickness across its length as compared to metal foil or metal wire. The roughness is a result of the conductive solute, e.g. gold and/or silver particles bonding together during the evaporation of the liquid. For a detailed discussion on the adherence of the metal particles as the fluid conductive lines are heated or as the liquid dries, reference should be made to the Mei et al. paper.

In the following discussion of a non-limiting embodiment of the invention, strips of a conductive liquid solution are applied by an ink jet process to a surface of a glass sheet or blank used in the manufacture of vehicular transparencies, e.g. a laminated automotive windshield. This non-limiting embodiment of the invention can be practiced to, among other things, replace the wires embedded in a plastic interlayer of a laminated windshield. Although not limiting to the invention, the conductive liquid solution used in the non-limited embodiment of the invention under discussion can be of the types discussed in Mei et al. paper.

As is appreciated by those skilled in the art, the invention is not limited to the practice of manufacturing a laminated automotive windshield, and the invention can be practiced on monolithic or laminated transparencies for any type of vehicle such as, but not limiting the invention thereto, land vehicles such as, but not limiting the invention thereto, trucks, cars, motorcycles, and/or trains, to air and/or space vehicles, and to above and/or below water vehicles. Further, the transparency can be any type of monolithic or laminated vehicular transparency such as, but not limiting the invention thereto, an automotive windshield, an automotive sidelight, a moon roof and a rear window. Still further, the invention can be practiced on monolithic, laminated and/or multiple glazed windows for residential homes, commercial buildings, oven doors, microwave ovens and refrigerator doors.

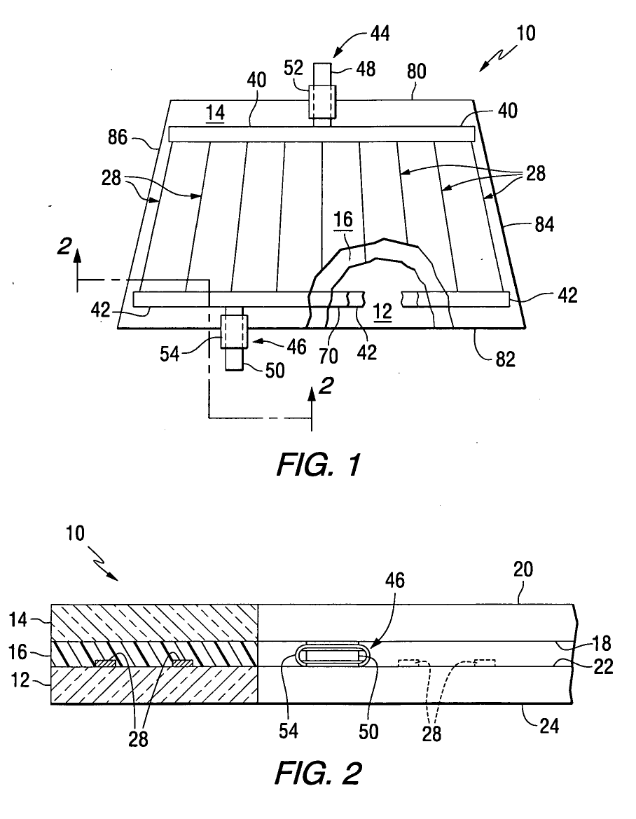

With reference to FIG. 1 there is shown an automotive windshield 10 incorporating features of the invention. The windshield 10 includes a pair of glass sheets or blanks 12 and 14, secured together by a plastic sheet 16 of the type used in the art of fabricating automotive windshields or laminating glass sheets, e.g. polyvinyl butyral (“PVB”), polyvinyl chloride (“PVC”) or polyurethane. In the following discussion of the windshield 10, the sheet 12 is the outer sheet, and the sheet 14 is the inner sheet, as the windshield is mounted in the vehicle. With reference also to FIG. 2, inner surface 18 of the inner sheet 14 faces the exterior of the vehicle, and outer surface 20 of the inner sheet 14 faces the interior of the vehicle; inner surface 22 of the outer sheet 12 faces the interior of the vehicle, and outer surface 24 of the outer sheet 12 faces the exterior of the vehicle. The outer surface 20 of the inner sheet 14 is also referred to as the No. 4 surface, the inner surface 18 of the inner sheet 14 is also referred to as the No. 3 surface, the inner surface 22 of the inner sheet 12 is also referred to as the No. 2 surface, and the outer surface 24 of the outer sheet 12 is also referred to as the No. 1 surface, of the windshield as mounted or as to be mounted.

As can be appreciated by those skilled in the art, the invention is not limited to the composition of the glass sheets 12 and 14, for example and not limited to the invention, the glass sheets can be clear or tinted soda-lime-silicate glass, borosilicate glass, or any type of refractory glass, for example, of the type disclosed in U.S. Pat. Nos. 5,030,592; 5,240,886, and 5,593,929 which patents are hereby incorporated by reference. The glass sheets can be annealed, tempered or heat strengthened. Glass sheets used in the manufacture of windshields are preferably annealed glass sheets. The glass sheets 12 and 14, and the plastic sheet 16 can have uniform thickness or can have a wedged cross section as disclosed in U.S. Pat. No. 4,998,784, which document is hereby incorporated by reference.

With continued reference to FIG. 1, electrically conductive strips or lines 28 incorporating features of the invention are applied to a surface of one or both of the glass sheets 12 and 14 and/or a surface of the plastic sheet 16 to provide conductive strips in the vision area of the windshield. In the following discussion, conductive strips or lines 28 that are applied to the glass are initially fluid and are referred to as “fluid conductive strips, lines or grid lines 28.” After the fluid conductive strips are dried, e.g. by heating, the conductive strips or lines 28 are referred to as “solid conductive strips, lines or grid lines 28.” The term “vision area” as used herein and in the claims is the area of the transparency through which a person looking at one side of the transparency views the environment on the other side of the transparency. In the present non-limiting embodiment of the invention under discussion, the vision area of the windshield is the area of the windshield through which the vehicle operator and passenger, if present, views the environment outside the vehicle and in front of the windshield.

In the preferred practice of the invention, the fluid conductive lines 28 are applied to the inner surface 22 of the outer sheet 12 of the windshield 10, e.g. the No. 2 surface of the windshield. As can be appreciated, the invention is not limited thereto, and the conductive lines 28 can be applied to any or all of the No. 1, 2, 3 and 4 surfaces of the windshield 10, and/or one or both of the major surfaces of the plastic sheet 16. In the instance when solid conductive strips 28 are on two or more surfaces of the glass sheets and/or plastic sheet, the solid conductive strips are electrically interconnected in any convenient manner within and/or without the perimeter of the laminated windshield to collectively and/or individually power the solid conductive strips 28. Although the invention contemplates applying the conductive lines 28 to the plastic sheet 16, as can be appreciated by those skilled in the art, the dimensional changes in the plastic sheet during laminating may result in discontinuities in the solid conductive lines 28. In the instance when the fluid conductive strips 28 are applied to the No. 1 and/or No. 4 surface(s) of the windshield 10, it is preferred, but not limiting to the invention, to provide a protective coating over the solid conductive strips, for example, a metal oxide coating such as but not limited to, silica and/or alumina, to protect the solid conductive strips from chemical and/or mechanical damage.

In the non-limiting embodiment of the invention shown in FIG. 1, each of the solid conductive strips 28 is interconnected at one end by a first bus bar 40, and interconnected at the other end by a second bus 42. The bus bars 40 and 42 are not limiting to the invention and can be any of the types known in the art, e.g. but not limiting to the invention of the type disclosed in U.S. Pat. No. 6,791,065B2, which document is hereby incorporated by reference. The bus bars 40 and 42 are usually wider than the solid conductive strips 28 and are positioned outside the vision area so that they are less likely to be visible to a vehicle operator looking through the vision area of the windshield 10.

Each bus bar has a lead assembly 44 and 46, respectively including a lead 48 and 50, respectively, mounted in an electrically non-conductive and hermetically sealed sleeve 52 and 54, respectively, extending from its respective one of the bus bars 40 and 42 beyond the edge of the laminated sheets to provide external electrical access to each of the bus bars, e.g. electrical connection to a power source, such as a vehicle battery (not shown).

For a more detailed discussion of the lead assemblies 44 and 46 reference should be made to the above-mentioned U.S. Pat. No. 6,791,065B2. As can be appreciated by those skilled in the art, the invention is not limited to the lead assemblies 44 and 46 used to make electrical contact to the bus bars 40 and 42, respectively, and any type of lead assembly that provides external electrical access to internal bus bars can be used in the practice of the invention.

Further, as can be appreciated by those skilled in the art, the solid conductive lines 28 on the surface 22 of the glass sheet 12 are in the vision area of the operator, and passengers, of the vehicle. In one non-limiting embodiment of the invention, the width of the solid conductive lines 28 is sufficiently narrow, e.g. equal to or less than 0.05 millimeters (“mm”), e.g. 0.025 mm, so that at least the vehicle operator when viewing through the vision area of the windshield does not readily see the solid conductive lines. In other non-limiting embodiments of the invention, the conductive lines 28 in the vision area can have a width in the range of up to 0.20 mm, e.g. up to 0.15 mm, or up to 0.010 mm, or up to 0.05 mm, such as 0.025 mm. The thickness of the solid conductive lines 28 in the vision area is not limiting to the invention and is sufficient to provide the conductive lines with a cross sectional area sufficient to heat and melt at least ice and snow along the No. 1 surface of the windshield 10 and/or to evaporate condensation from the No. 1 or 4 surfaces of the windshield 10. As discussed above in the Mei et al. paper, the solid silver conductive lines have an electrical resistivity of 4.6E-6 (ohm cm). As can be appreciated by those skilled in the art, the cross sectional area of the conductive strips required to melt snow and ice and/or evaporate condensation from any surface of the windshield 10 as discussed above can be determined from the electrical resistivity.

It should be appreciated that the conductive lines 28 can be applied to other surfaces of a vehicle, for example a side window or back window. The conductive lines can function as heating elements as discussed above and/or provide other features, such as but not limited to antennas or crack detectors, as will be discussed later in more detail.

In accordance to the invention, the solid conductive lines 28 in the vision area can have a width less than the width of the solid conductive lines in the non-vision areas of the windshield, and a thickness greater than the thickness of the solid conductive lines in the non vision to provide the solid conductive lines with a constant cross sectional area throughout their length. The thickness of the solid conductive lines can be increased to obtain the required resistively by making a number of passes over the length of the fluid or solid conductive lines to increase the thickness of the solid conductive lines. The width of the fluid conductive lines 28 can be increase by increasing the area of the orifice of the ink jet printer and/or making additional passes over the liquid or solid conductive lines.

The liquid conductive lines 28 can be applied to a surface of the glass sheet or blank 12, e.g. surface 22, before it is shaped, e.g. apply the conductive lines to a flat surface. In this instance the fluid conductive lines are dried during the sheet shaping process to provide solid conductive lines. As can now be appreciated by those skilled in the art and not limiting to the invention, the substrate having the conductive strip is preferably not heated above the melting point of the conductive metal. For example and not limiting to the invention, the melting point of silver is 1760° F. (960° C.); therefore, a substrate having a solid silver strip is preferably not heated at or above 1760° F. (960° C.). Further, the melting point of gold is 1945° F. (1062° F.); therefore, a substrate having a solid gold conductive strip is preferably not heated at or above 1945° F. (1062° C.). Briefly the sheet shaping process, which is well known in the art, includes controllably heating the sheet to greater than 1004° F. (540° C.), shaping the sheet and controllably cooling the sheet to anneal the shaped glass sheet. The invention also contemplates shaping the sheet, applying the liquid conductive strips, and heating the shaped sheet to a temperature of 572° F. (300° C.) to provide the solid conductive lines.

With continued reference to FIGS. 1 and 2 as required, in a non-limiting embodiment of the invention wherein the plastic sheet 16 includes conductive lines 28, the plastic sheet 16 having the bus bars 40 and 42 attached thereto by a pressure sensitive adhesive 70 overlays and covers the surface 22 of the sheet 12. The bus bars 40 and 42 have a length sufficient to extend across their respective ends of the solid conductive strips 28. The top bus bar, i.e. bus bar 40, and its respective lead 48, are contiguous with one another and the bottom bus bar 42 and its respective lead 50, are similarly contiguous with one another and are made of copper foil. The sheet 14 overlays and covers the plastic sheet 16. Each of the leads 48 and 50 has a sufficient length to extend from the edge of the windshield. A portion of the copper leads 48 and 50 extending out from between the glass sheets, and a portion of the leads between the glass sheets have a moisture and air impervious sleeve of the type disclosed in the above-mentioned U.S. Pat. No. 6,791,065B2.

The shaped sheets 12 and 14, and the plastic sheet 16 are laminated together in any conventional manner. For a more detailed discussion of fabricating the windshield subassembly and laminating the windshield subassembly, reference should be made to the above-mentioned U.S. Pat. No. 6,791,065B2.

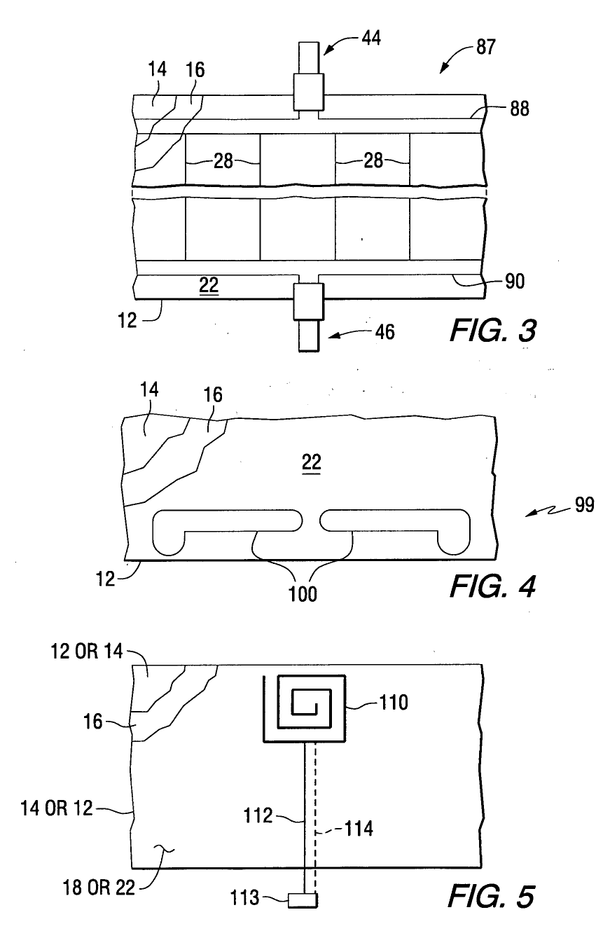

As is appreciated, the solid conductive strips 28 can extend from top edge 80 of the windshield 10 to bottom edge 82, or between the edges 80 and 82, of the windshield, i.e. spaced vertical solid conductive strips 28 as shown in FIG. 1, or from one side edge 84 to other side 86, or between the sides 84 and 86, i.e. spaced horizontal solid conductive strips as applied for automotive rear windows. Although in the practice of the invention discussed above, the conductive liquid solution was applied by the ink jet process to provide thin unnoticeable solid conductive strips in the vision area of a transparency, e.g. an automotive windshield, the invention is not limited thereto. More particularly and with reference to FIG. 3, there is shown upper and lower center portions of an automotive windshield 87 having the glass sheets 12 and 14 and the interlayer 16. The glass sheet or blank 12 has the solid conductive lines 28 connected at one end to bus bar 88 and at the other end to bus bar 90. The lead assembly 44 provides external electrical access to the bus bar 88, and the lead assembly 46 provides external electrical access to the bus bar 90.

The solid conductive strips 28 and the bus bars 88 and 90 are contiguous and are provided by applying the conductive liquid solution in any convenient manner, e.g. by an inkjet application technique to the surface 22 of the sheet 12 and heating the sheet 12 to dry the applied conductive liquid solution as discussed above. The width, thickness and length of the bus bars 88 and 90 can be obtained by building up the thickness of the applied conductive liquid solution by repeated spraying of the area or maintaining the jets in position until the desired dimensions are obtained; both techniques of applying the conductive liquid solution to increase the thickness and width of deposited images are known in the art and no further discussion is deemed necessary. In another non-limiting embodiment of the invention, bus bars are provided by applying, in any convenient manner, e.g. by ink jet printing, or silk screening a conductive ceramic paste, and the solid conductive strips 28 by applying the conductive liquid solution as discussed above to the wet or dry bus bars and thereafter heating the fluid conductive strips and the bus bars.

Shown in FIG. 4 is a non-limiting embodiment of the invention to heat the wiper rest area of windshield 99. As is known by those skilled in the art, the wiper rest area is the rest position of the windshield wipers on the No. 1 surface of the windshield. Because the wiper rest area is outside the vision area, any size area and/or pattern design can be used and are not limiting to the invention. The electrically conductive members 100 can be, but not limited thereto, applied to the No. 2 surface, opposite to the expected wiper rest area of the No. 1 surface of the windshield 99. In the practice of the invention, but not limited thereto, the conductive liquid solution is applied to the No. 2 surface of the windshield 99, e.g. the inner surface 22 of the sheet 12, in any convenient manner, e.g. but not limiting the invention thereto by an inkjet application technique or by brushing the conductive liquid solution until the desired shaped and thickness of the conductive members 100 is obtained. The conductive members 100 are individually connected to an external power source, e.g. a battery (not shown). For a detailed discussion regarding the conductive members for heating wiper rest areas, reference can be made to U.S. Pat. No. 5,653,903 to Harry S. Koontz, which patent is hereby incorporated by reference.

As can be appreciated, the invention contemplates applying the conductive liquid solution to surfaces to provide other electrically conductive members, e.g. and not limiting to the invention, an antenna for receiving and sending signals, and/or a crack detector. The antenna can be, but not is limited to, a slot antenna or single and multi-element antennas, and the crack detector can be, but is not limited to, detectors for security systems, sensors, or glass break detection for vehicle and home windows. More particularly, and with reference to FIG. 5, the conductive member is a grid 110 for an antenna or for a glass crack detector. When the grid 110 acts as an antenna, solid conductive strip 112 connects the grid 110 to appropriate electronics 113, e.g. a transmitting and/or receiving source. When the grid 110 is a crack detector, the solid conductive strip 112 and the solid conductive strip 114 (shown in phantom) are connected to the appropriate electronics 113, e.g. electronics of a crack detector. Antennas and crack detectors are well known in the art and external electrical connections to conductive members between a pair of laminated sheets are well known in the art, and no further discussion is deemed necessary.

As can be appreciated, the conductive member 110 can be applied to any surface of a substrate, e.g. but not limiting to the invention, surface 22 or 18 of the sheet 12 or 14, respectively, and can be in the vision area or the non-vision area. When in the vision area the conductive lines of the conductive member 110 are configured to minimize visual interference.

As can now be appreciated, the invention is not limited to the embodiments of the invention discussed above, and the conductive member 110 applied in accordance to the invention to any surface that requires on or more electrically conductive line elements.

The above technology items listed above are well known in the art and no further discussion is deemed necessary.

As is now appreciated, the components, e.g. the solid conductive strips 28 shown in FIG. 1, the conductive member members 100 shown in FIG. 4, the grid 110 shown in FIG. 5, and the conductive members listed above can be used with each other and other technology. For example, and not limiting to the invention, the conductive lines 28, the conductive members 100 and the grid 110 can be used with each other and with a solar control coating or a conductive coating of the type disclosed in EPA 00939609.4, which document is hereby incorporated by reference, and the conductive members 100 and grid 110 can be used with the heatable members disclosed in International Application No. PCT U.S. 2003/030487, which document is hereby incorporated by reference.

As can now be appreciated, the fluid conductive lines 28, the fluid conductive members 100, the fluid grid 110 and the above mentioned conductive members can be applied to the surface of a flat and/or curved substrate, e.g. but not limiting to the invention, a flat glass piece or bent glass piece. The procedure can include, but not limiting to the invention, applying the conductive liquid solution to a substrate and thereafter heating the substrate; applying the conductive liquid solution to a surface of a substrate during the heating of the substrate, and/or applying the conductive liquid solution to a shaped substrate, and heating the substrate.

By way of illustration and not limiting to the invention, the invention is practiced to manufacture tempered glass having heatable conductive strips, e.g. but not limiting the invention thereto automotive rear windows. In one non-limiting embodiment of the invention, a pair of spaced ceramic frit bus bars is silk screened onto the surface of a soda lime glass blank, or a pair of spaced bus bars of conductive liquid solution are applied as discussed above, and the fluid conductive strips applied on the surface of the glass blank between and in contact with the bus bars. The glass blank is heated to a temperature in the range of 1180 to 1280° F. (635 to 693° C.) and rapidly cooled to temper the glass. In another non-limiting embodiment of the invention, the glass blank is tempered, the bus bars and the fluid conductive strips applied, and the tempered glass heated to solidify the bus bars and the fluid conductive strips without removing the temper from the glass.

While specific embodiments of the invention have been described in detail, it will be appreciated by those skilled in the art that various modifications and alternatives to those details can be developed in light of the overall teachings of the disclosure. Further, the presently preferred embodiments described herein are meant to be illustrative only and not limiting as to the scope of the invention which is to be given the full breadth of the appended claims and any and all equivalents thereof.

What is claimed is:

1. A method of applying an electrically conductive strip to a transparency selected from a transparency for a land, air, space, above water and below water vehicle; a transparency for a residential and commercial structure, and a transparency for viewing into a compartment, comprising:
applying an electrically conductive, minuscule size particle containing liquid solution or an electrically conductive particle free liquid solution to a surface of a transparency to provide a liquid conducting member, and
heating the liquid conducting member to provide a solid conductive member adhered to the surface of the transparency.

2. The method according to claim 1, wherein the applying step is practiced by applying the liquid solution using contact application techniques and/or non-contact application techniques.

3. The method according to claims 2, wherein the applying step is practiced by at least one contact application technique selected from painting with a brush, painting with a porous flexible liquid holding member, dispensing the liquid solution by a pen.

4. The method according to claim 2, wherein the applying step is practiced by at least one non-contact application technique selected from spraying the liquid solution and applying the liquid solution by non-contact printing.

5. The method according to claim 4, wherein the applying step is practiced by applying the liquid solution by inkjet printing.

6. The method according to claim 5, wherein the liquid solution is an electrically conductive, minuscule size particle containing liquid solution having on the average no more than one particle per 5 cubic centimeters of liquid solution and a maximum linear distance between two points on the periphery of the one particle of no more than 95% of the opening of an orifice of the ink jet printer, the one particle defined as large particle, with other particles in the liquid solution having a maximum linear distance no greater than the large particle.

7. The method according to claim 6, wherein the liquid solution has particles in a range of no greater than 100 microns.

8. The method according to claim 5, wherein the solid conductive member is a portion of an electrically conductive member.

9. The method according to claim 8, wherein the electrically conductive member is selected from (a) a plurality of spaced electrically conductive strips, each strip having a first end in electrical contact with a first bus bar and a second end in electrical contact with a second bus bar; (b) an electrically heatable member on one surface of a substrate to heat an area of an opposing surface of the substrate opposite the heatable member; (c) a detector for cracks in the transparency; (d) an antenna for receiving and/or transmitting signals; (e) security systems sensor lines on glass; (f) on-glass break detector for vehicle and home windows; (g) antitheft lines for an automotive transparency; and(h) a slot antenna on glass.

10. The method according to claim 9, wherein the transparency is an automotive transparency selected from a windshield, sidelight, moon roof and rear window.

11. The method according to claim 9, wherein the substrate is a glass sheet having a first major surface and an opposite second surface with an area of the second surface designated as the wiper rest area and the electrically conductive member is an electrically heatable member positioned on the first surface opposite to the designated wiper rest area.

12. The method according to claim 9, wherein the substrate is a glass sheet having a first major surface and an opposite second surface, and the electrically conductive member is a detector for cracks in the substrate positioned on the first major surface of the sheet.

13. The method according to claim 9, wherein the substrate is a glass sheet having a first major surface and an opposite second surface and the electrically conductive member is an antenna to receive and/or transmit signals positioned on the first major surface of the glass sheet.

14. The method according to claim 9 further comprising positioning a plastic sheet over the first major surface of the glass sheet, positioning a second glass sheet over the plastic sheet, and laminating the plastic sheet and the glass sheets together.

15. A method of applying an electrically conductive strip to a vehicle transparency having an area designated as a vision area, comprising:
providing a glass sheet having an area designated as the vision area;
applying electrically conductive first and second, spaced apart bus bars on a surface of the glass sheet; and
applying a plurality of spaced conductive strips in a vision area of a glass sheet, wherein a first end of each of the conductive strips is in electrical contact with the first bus bar and an opposing end of each of the conductive strips is in electrical contact with the second bus bar, the conductive strip applying step comprising:
applying an electrically conductive, minuscule size particle containing liquid solution or electrically conductive particle free liquid solution by an inkjet application technique to the surface of the glass sheet to provide a plurality of spaced liquid electrically conductive strips on the surface of the glass sheet, and
heating the liquid electrically conductive members to provide a plurality of spaced solid electrically conductive strips adhered to the vision area of the glass sheet.

16. The method according to claim 15, wherein the conductive strips have a width no greater than 0.20 millimeters.

17. The method according to claim 16, wherein the width of the conductive strips is no greater than 0.15 millimeters.

18. The method according to claim 17, wherein the width of the conductive strips is no greater than 0.05 millimeters.

19. The method according to claim 15, wherein the surface of the sheet having the conductive strips is a first major surface of the sheet, and further comprising providing a first electrical lead to the first bus bar, providing a second electrical lead to the second bus bar, positioning a plastic sheet over the first surface of the glass sheet; positioning a second glass sheet over the plastic sheet, and laminating the glass sheets and plastic sheet together to provide a laminated windshield, wherein portions of the first lead and the second lead extend beyond a peripheral edge of the laminated windshield.

20. A transparency selected from a transparency for a land, air, space, above water and below water vehicle; a transparency for residential and commercial structures, and a transparency for viewing into a compartment, comprising:
a solid electrically conductive strip having a first surface adhered to a surface portion of the transparency, the conductive strip having conductive particles bonded together as a result of evaporation of a conductive solute of a conductive liquid solution.

21. The transparency of claim 20, wherein the solid conductive strip is a portion of an electrically conductive member selected from (a) a plurality of spaced electrically conductive strips, each strip having a first end in electrical contact with a first bus bar and a second end in electrical contact with a second bus bar; (b) an electrically heatable member on one surface of a substrate to heat an area of an opposing surface of the substrate opposite the heatable member; (c) a detector for cracks in the transparency; (d) an antenna for receiving and/or transmitting signals; (e) security systems sensor lines on glass; (f) on-glass break detector for vehicle and home windows; (g) antitheft lines for an automotive transparency; and(h) a slot antenna on glass.

22. A transparency for an automobile, comprising
at least one glass sheet having a first major surface and an opposite second major surfaces, and
a plurality of spaced solid electrically conductive strips having a first surface and an opposite second surface, one end of the strips connected to a first bus bar and other end of the strips connected to a second bus bar, the bus bars and first surface of the conductive strips secured to the first major surface of the at least one glass sheet, wherein the conductive strip has conductive particles bonded together as a result of evaporation of a conductive solute of a conductive liquid solution.

23. The transparency according to claim 22, wherein the transparency is an automotive windshield, at least a portion of the conductive strips is in the vision area of windshield, and at least a portion of the conductive strips has a width of no greater than 0.20 millimeters.

24. The transparency according to claim 23, wherein the at least one glass sheet is a first glass sheet, and further comprising a plastic sheet over the bus bars and the conductive strips and a second glass sheet over the plastic sheet, wherein the sheets are laminated together, a first lead having one end spaced from a peripheral edge of the windshield and opposite end in electrical contact with the first bus bar, and a second lead having one end spaced from the peripheral edge of the windshield and opposite end in electrical contact with the second bus bar.
